(19) United States
(12) Patent Application Publication
(10) Pub. No.: US 2018/0138784 A1
(43) Pub. Date: May 17, 2018

(54) METHOD AND SYSTEM FOR COOLING OF AN ELECTRIC MOTOR

(71) Applicant: BAE Systems Hägglunds Aktiebolag, Örnsköldsvik (SE)

(72) Inventor: Viktor LASSILA, Arnäsvall (SE)

(73) Assignee: BAE Systems Hägglunds Aktiebolag, Örnsköldsvik (SE)

(21) Appl. No.: 15/570,267

(22) PCT Filed: Apr. 26, 2016
(86) PCT No.: PCT/SE2016/050370

§ 371 Date: Oct. 27, 2017

(30) Foreign Application Priority Data
May 7, 2015 (SE) 1550589-4

(51) Int. Cl. H02K 9/193

(52) U.S. Cl. CPC H02K 9/193; H02K 2213/09

(57) ABSTRACT

The present invention relates to a system for cooling of an electric motor having a rotor and a stator. The system comprises at least one cooling medium applicator arranged to apply a cooling medium onto said stator. Said cooling medium applicator is arranged to be controlled based on a cooling need of the stator so that the cooling medium is applied onto an area of the stator wherein a cooling need exists. The present invention also relates to a method for cooling of an electric motor. The present invention also relates to a platform.

### TECHNICAL FIELD

The invention relates to a method for cooling of an electric motor according to the preamble of claim 1. The invention also relates to a system for cooling of an electric motor. The invention also relates to a motor vehicle. The invention also relates to a computer program and a computer program product.

### BACKGROUND

During operation electric motors are heated wherein cooling is required in order to divert the heat. Cooling of electric motor may be performed using different types of cooling mediums such as for example air, water or oil.

For high performing electric motors efficient cooling is highly significant for maintained performance. Cooling of the active parts of the electric motor directly affects the performance. Liquid cooling using for example oil can hereby provide efficient cooling.

An important motor component having a large need for cooling is the stator of the electric motor and in particular its end portions encompassing the coil ends of the stator winding. Many cooling devices are therefore configured to apply a cooling medium onto the stator ends and the thereby often exposed coil ends.

The stator winding generally comprises a lacqured, isolated conductor and a known problem with cooling devices wherein the cooling medium in liquid form is directly flushed onto the coil ends is erosion. The often statically applied stream of cooling medium erodes the lacquer comprised in the stator winding within the striking surface of the stream, which long-term risks damaging the motor.

This problem is generally solved by means of applying the cooling medium in the form of a spray (aerosol particles) that is sprayed across the stator winding and in particular its coil ends by the end portions of the stator instead of applying the cooling medium in a substantially continuous stream.

Such a solution is for example described by U.S. Pat. No. 2,648,085 wherein a cooling medium is sprayed onto the stator winding.

A problem with spray cooling is that a certain flow is required in order to generate the spraying/mist. If the flow is insufficiently low the desired spraying will not be accomplished whereby the cooling will become unsatisfactory. Hereby the risk is that so called local hot spot will be created. The performance of the electric motor is affected by the hottest part and the total heat of the electric motor reduces.

### OBJECT OF THE INVENTION

An object of the present invention is to provide a device and a method for cooling of an electric motor that solves or at least alleviated one or more of the above mentioned problems associated with prior art cooling devices.

A particular object of the present invention is to provide a device and a method for cooling of an electric motor that provides efficient cooling of the electric motor.

### SUMMARY OF THE INVENTION

These and other objects, apparent from the following description, are achieved by a method, a device, a computer program and a computer program product of the type stated by way of introduction and which in addition exhibits the features recited in the characterising clause of the appended claims 1, 9, 22 and 23. Furthermore, the objects are achieved by a platform according to claim 20. Preferred embodiments of the device, method and platform are defined in appended dependent claims 2-8, 10-19 and 21.

According to the invention the objects are achieved by a method for cooling of an electric motor having a rotor and a stator. The method comprises the step of applying cooling medium onto said stator using at least one cooling medium applicator. The method further comprises the step of controlling during application of the cooling medium said cooling medium applicator so that the cooling medium is applied onto areas of the stator where cooling is required.

This enables to control the cooling onto areas of the stator having a particular need for cooling whereby the cooling can be streamlined. Hereby for example in connection to fault conditions wherein a particular winding runs hot due to isolation being worn down or similar the cooling medium applicator may be controlled so that cooling medium is applied onto the winding that has run extra hot. Furthermore it is enabled to control the cooling medium applicator by moving it so that the cooling medium is distributed over a larger area having a cooling need for efficient cooling of the stator and consequently also of the electric motor. The cooling medium applicator may be controlled to be directed towards and area and controlled to cause movement such as for example oscillating movement within the area towards which the cooling medium applicator is directed so that the cooling medium is distributed within the area having a need for efficient cooling.

According to an embodiment of the method the step of controlling said cooling medium applicator comprises directing said cooling medium applicator towards the area having a cooling need by means of moving said cooling medium applicator relative to said stator. By means of thus controllably directing the cooling medium applicator towards the area of the stator having a cooling need an efficient way of accomplishing cooling of the areas of the stator having a particular need for cooling is provided.

According to an embodiment the method comprises the step of ejecting said cooling medium using at least one nozzle supported by a holder for said at least one nozzle. Hereby is enabled efficient cooling by means of for example a liquid cooling medium. Hereby is enabled to allow movement of the nozzle relative to the holder. The respective cooling medium applicator may comprise one or more nozzles. A nozzle may comprise one or more outlets for ejection of the cooling medium.

According to an embodiment of the method the step of controlling said cooling medium applicator comprises the step of controlling movement of said at least one nozzle relative to said holder. By thus controllably moving the nozzle for desired direction of the cooling medium for cooling of areas of the stator having a particular need. Cooling using a controllable nozzle enables cooling suing a liquid cooling medium in spray form and cooling in the form of one or more streams.

According to an embodiment of the method the step of controlling said cooling medium applicator comprises controlling the movement of said holder relative to said stator. Hereby an alternative way of accomplishing controlled movement of the cooling medium applicator for efficient distribution of the cooling medium is provided. The holder is according to a variant arranged moveably attached for control of the same.

According to an embodiment application of cooling medium is performed using at least two cooling medium applicators, whereby the step of controlling comprises the step of de-activating at least one cooling medium applicator so that a larger flow of cooling medium is allowed of the still activated cooling medium applicator. By selecting to de-activate certain cooling medium applicators, according to a variant de-activate nozzles of some certain cooling medium applicators, the flow increases in others for more efficient cooling using the still activated cooling medium applicator. This applies to cooling medium applicators having a joint supply of cooling medium. De-activation is according to a variant accomplished by means of de-activating the nozzle of one cooling medium applicator provided with a nozzle. In case the cooling medium applicators comprise nozzles for accomplishing a spray functionality such as a liquid mist it is enabled by means of de-activation of a cooling medium applicator to maintain the spray functionality at lower cooling medium flows. Hereby is consequently achieved an energy efficient application of the cooling medium.

According to an embodiment application is performed using at least one cooling medium applicator comprising at least two nozzles, wherein the step of controlling comprises the step of de-activating at least one nozzle so that a larger flow of cooling medium is allowed in the nozzle still being activated. By means of de-activating some certain nozzles of a cooling medium applicator, the flow increases in others for more efficient cooling using the nozzle still being activated. In case the cooling medium applicator comprises nozzles for accomplishing a spray functionality such as a liquid mist it is enabled by means of de-activation of at least one of the nozzles to maintain the spray functionality at lower cooling medium flows since the flow of the nozzle still being activated increases. Hereby is consequently achieved an energy efficient application of the cooling medium. According to an embodiment a cooling medium applicator comprises at least two separable chambers wherein a respective chamber is connected to at least two nozzles, wherein the respective chamber has a joint supply of cooling medium. Hereby is enabled to increase the flow by means of de-activating a chamber, which means that each nozzle of this chamber is de-activated. Furthermore it is enabled to arrange nozzles of one chamber directed towards one area of the stator and nozzles of another chamber directed towards another area, whereby de-activation of nozzles of the one chamber by means of de-activation of the one chamber results in directed cooling of the one area of the stator and de-activation of nozzles of the other chamber results in directed cooling towards the other area, in both cases with an increased flow compared to if both chambers/nozzles where to be activated.

According to an embodiment the method comprises the step of determining a cooling need of the stator before the step of application of cooling medium takes place. By thus determining the cooling need of the stator comprising determining the cooling need of different areas of the stator control of the cooling medium applicator is facilitated for application of the cooling medium onto an area where a particular need for cooling exists.

According to the invention the objects are achieved by a system for cooling of an electric motor having a rotor and a stator. The system comprises at least one cooling medium applicator arranged to apply a cooling medium onto said stator. Wherein said cooling medium applicator is arranged to be controlled based on a cooling need of the stator so that the cooling medium is applied onto an area of the stator where a cooling need exists.

This enables to control the cooling onto areas of the stator having a particular need for cooling whereby the cooling can be streamlined. Hereby for example in connection to fault conditions wherein a particular winding runs hot due to isolation being worn down or similar the cooling medium applicator may be controlled so that cooling medium is applied onto the winding that has run extra hot. Furthermore it is enabled to control the cooling medium applicator by moving it so that the cooling medium is distributed over a larger area having a cooling need for efficient cooling of the stator and consequently also of the electric motor. The cooling medium applicator may be controlled to be directed towards and area and controlled to cause movement such as for example oscillating movement within the area towards which the cooling medium applicator is directed so that the cooling medium is distributed within the area having a need for efficient cooling.

According to an embodiment of the system said cooling medium applicator is moveably arranged relative to said stator for directed control of said cooling medium applicator. By means of thus controllably directing the cooling medium applicator towards the area of the stator having a cooling need an efficient way of accomplishing cooling of the areas of the stator having a particular need for cooling is provided.

According to an embodiment of the system said cooling medium applicator comprises a nozzle for ejecting said cooling medium and a holder for supporting said at least one nozzle. Hereby is enabled efficient cooling by means of for example a liquid cooling medium. Hereby is enabled to allow movement of the nozzle relative to the holder. The respective cooling medium applicator may comprise one or more nozzles. A nozzle may comprise one or more outlets for ejection of the cooling medium.

According to an embodiment of the system said at least one nozzle is controllably moveably arranged relative to said holder. By thus controllably moving the nozzle for desired direction of the cooling medium for cooling of areas of the stator having a particular need. Cooling using a controllable nozzle enables cooling suing a liquid cooling medium in spray form and cooling in the form of one or more streams.

According to an embodiment of the system said holder is controllably moveably relative to said stator. Hereby an alternative way of accomplishing controlled movement of the cooling medium applicator for efficient distribution of the cooling medium is provided. The holder is according to a variant arranged moveably attached for control of the same.

According to an embodiment of the system said cooling medium applicator is supported by means of a housing surrounding the electric motor.

According to an embodiment of the system the cooling medium applicator is supported by means of an end wall portion and/or an envelope wall of said housing.

According to an embodiment of the system the cooling medium applicator is supported by means of a rotor shaft of said rotor.

According to an embodiment application of cooling medium is arranged to be performed using at least two cooling medium applicators, whereby the system comprises means for de-activating at least one cooling medium applicator so that a larger flow of cooling medium is allowed of cooling medium applicator still being activated. By selecting to de-activate certain cooling medium applicators, according to a variant de-activate nozzles of some certain cooling medium applicators, the flow increases in others for more efficient cooling using the still activated cooling medium applicator. This applies to cooling medium applicators having a joint supply of cooling medium. De-activation is according to a variant accomplished by means of de-activating the nozzle of one cooling medium applicator provided with a nozzle. In case the cooling medium applicators comprise nozzles for accomplishing spray functionality such as a liquid mist it is enabled by means of de-activation of a cooling medium applicator to maintain the spray functionality at lower cooling medium flows. Hereby is consequently achieved an energy efficient application of the cooling medium.

According to an embodiment application is arranged to be performed using at least one cooling medium applicator comprising at least two nozzles, comprising means for de-activating at least one nozzle so that a larger flow of cooling medium is allowed in the nozzle still being activated. By means of de-activating some certain nozzles of a cooling medium applicator, the flow increases in others for more efficient cooling using the nozzle still being activated. In case the cooling medium applicator comprises nozzles for accomplishing a spray functionality such as a liquid mist it is enabled by means of de-activation of at least one of the nozzles to maintain the spray functionality at lower cooling medium flows since the flow of the nozzle still being activated increases. Hereby is consequently achieved an energy efficient application of the cooling medium. According to an embodiment a cooling medium applicator comprises at least two separable chambers wherein a respective chamber is connected to at least two nozzles, wherein the respective chamber has a joint supply of cooling medium. Hereby is enabled to increase the flow by means of de-activating a chamber, which means that each nozzle of this chamber is de-activated. Furthermore it is enabled to arrange nozzles of one chamber directed towards one area of the stator and nozzles of another chamber directed towards another area, whereby de-activation of nozzles of the one chamber by means of de-activation of the one chamber results in directed cooling of the one area of the stator and de-activation of nozzles of the other chamber results in directed cooling towards the other area, in both cases with an increased flow compared to if both chambers/nozzles where to be activated.

According to an embodiment the system comprises means for determining a cooling need of the stator. By thus determining the cooling need of the stator comprising determining the cooling need of different areas of the stator control of the cooling medium applicator is facilitated for application of the cooling medium onto an area where a particular need for cooling exists.

### DESCRIPTION OF THE DRAWINGS

A better understanding of the present invention will be had upon the reference to the following detailed description when read in conjunction with the accompanying drawings, wherein like reference characters refer to like parts throughout the several views, and in which:

FIG. 1 schematically illustrates a platform according to an embodiment of the present invention;

FIG. 2 schematically illustrates a cross section view of an electric motor comprising a system for cooling of the electric motor according to an embodiment of the present invention;

FIG. 3a schematically illustrates a system for cooling of the electric motor comprising a set of cooling medium applicators according to an embodiment of the present invention;

FIG. 3b schematically illustrates a system for cooling of the electric motor comprising a cooling medium applicator with a set of nozzles according to an embodiment of the present invention;

FIG. 3c schematically illustrates a system for cooling of the electric motor comprising a cooling medium applicator according to an embodiment of the present invention;

FIG. 3d schematically illustrates a system for cooling of the electric motor comprising a cooling medium applicator according to an embodiment of the present invention;

FIG. 4a schematically illustrates a system for cooling of the electric motor comprising a cooling medium applicator with double chambers with nozzles connected to the respective chambers applicator according to an embodiment of the present invention;

FIG. 4b schematically illustrates a system for cooling of the electric motor comprising a cooling medium applicator with double chambers with nozzles connected to the respective chambers applicator according to an embodiment of the present invention;

FIG. 5 schematically illustrates a flow diagram of a method for cooling of an electric motor according to an embodiment of the present invention.

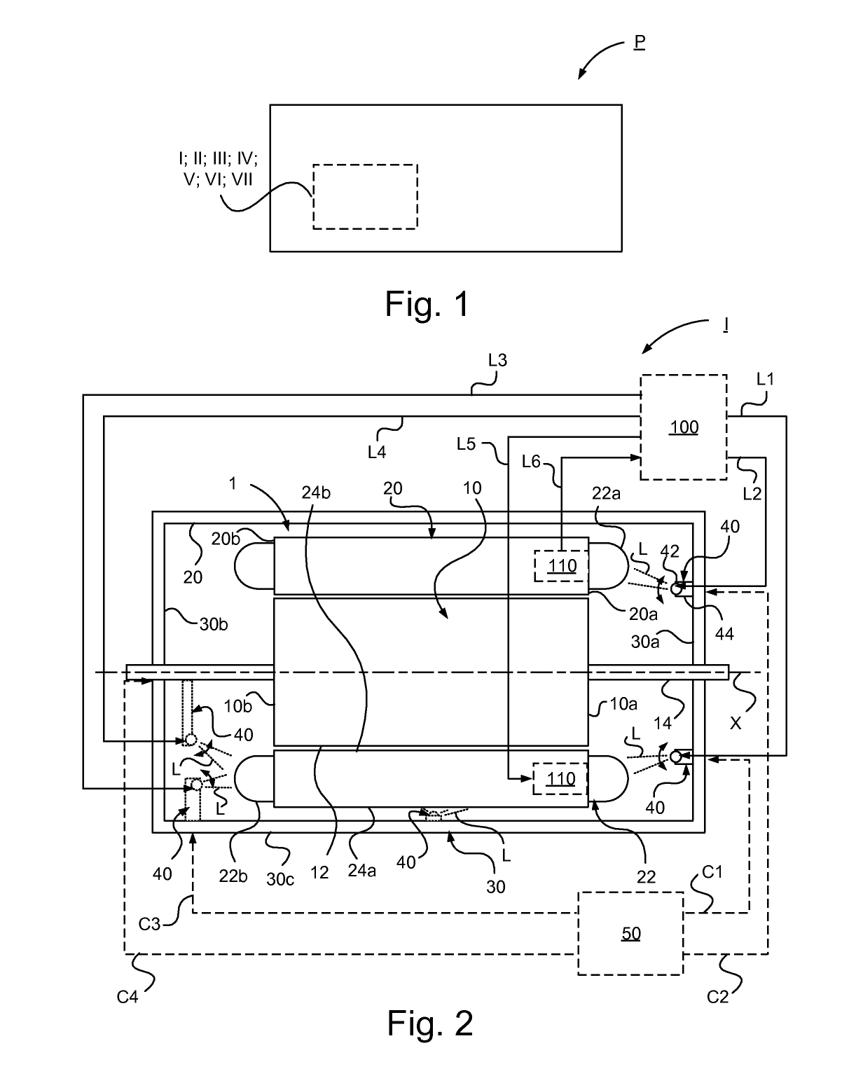

### DESCRIPTION OF EMBODIMENTS

Herein the term “link” refers to a communication link which may be a physical connector, such as an optoelectronic communication wire, or a non-physical connector, such as a wireless connection, for example a radio or microwave link.

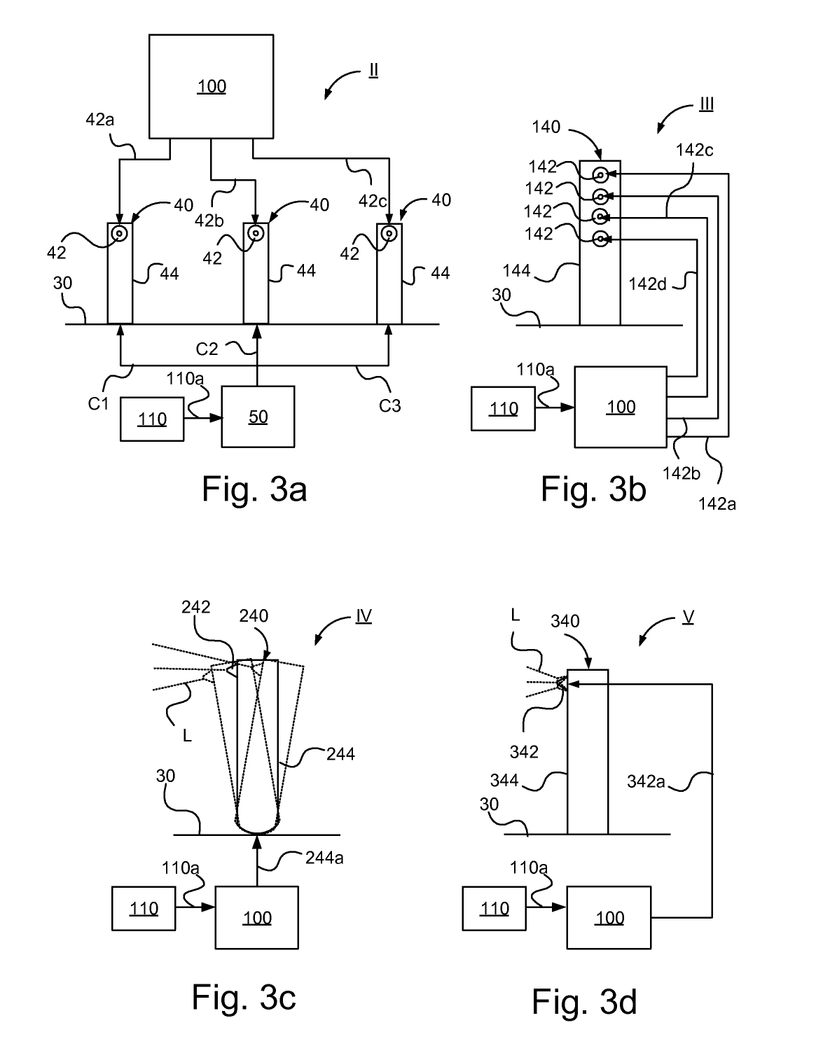

With reference to FIG. 2 a platform P is shown, wherein the platform P is comprised in a group comprising motor vehicles such as military vehicles, working vehicles, automobiles, boat, helicopter or similar, a power station, any electrically driven machine or corresponding device wherein the device comprises an electric motor for operation of the device. The platform P comprises at least one electric motor comprising a system I; II; III; IV; V; VI; for cooling of the electric motor 1 according to the present invention.

In an embodiment in which the electric motor 1 is comprised in a motor vehicle the electric motor is configured for operation of said motor vehicle, which thus constitutes an electrically driven motor vehicle. The system I; II; III; IV; V; VI; VII for cooling may be configured according to any of the below described embodiments.

In the embodiments according to the present invention the electric motor and its stator are arranged to be cooled by means of a cooling medium. Said cooling medium according to an embodiment comprises a liquid cooling medium. The liquid cooling medium may comprise any suitable liquid cooling medium. The liquid cooling medium according to an embodiment comprises oil. Said cooling medium according to an embodiment comprises a gaseous cooling medium. The gaseous cooling medium may be any suitable gaseous cooling medium. The gaseous cooling medium according to an embodiment comprises cold gas such as for example nitrogen gas. Said cooling medium according to an embodiment comprises carbonic acid.

FIG. 2 schematically illustrates a perspective view of part of an electric motor 1 comprising a system I for cooling of the electric motor according to an embodiment of the present invention.

The electric motor 1 is of inner rotor type comprising a rotor 10 and a stator 20 provided with windings. By electric motor 1 of inner rotor type is meant an electric motor 1 wherein the stator 20 is arranged to enclose the rotor 10. The exterior surface of the rotor 10 is arranged nearby and separated from the exterior surface of the stator 20. The rotor 10 is according to a variant constructed from stacked rotor plates, not shown. The rotor 10 is arranged concentrically relative to the stator 20. Said rotor is arranged to be coupled to a drive shaft, not shown, and is thus arranged to rotate the drive shaft. The rotor 10 has opposing end portion in the form of rotor ends 10a, 10b. The rotor ends 10a, 10b constitutes end surfaces of the cylinder shaped rotor 10.

The rotor 10 has an envelope surface 12 facing the stator 20 and constitutes what is herein referred to as the exterior surface of the rotor. The electric motor 1 further comprises a rotor shaft 14 which is coupled to the rotor 10 and extends axially from at least one rotor end 10a, 10b. The rotor shaft 14 is generally also cylinder shaped and arranged concentrically with the rotor 10 and the stator 20 so that its central axis coincides with the above mentioned central axis X of the electric motor 1. The rotor shaft 14 may be a one sided rotor shaft extending from a single side of the electric motor 1 or it may be a double sided rotor shaft extending from both sides of the electric motor 1 such as illustrated in FIG. 2.

During operation of the electric motor 1 the rotor 10 and thereby the rotor shaft 14 is caused to rotate, whereby the rotor shaft 14 is arranged to, outside of the electric motor, transfer a driving torque to a driving means (not shown), for example for propulsion of an electrically driven motor vehicle.

The stator 20 is according to a variant constructed from stacked stator plates (not shown). The stator 20 comprises a stator winding 22. The stator winding according to a variant comprises a set of electrically conductive wires/conductors, preferably copper wires, through which a current is arranged to be conducted for driving the electric motor 1. Said wires may be of different thickness. Said stator winding 22 is arranged to run axially so that the winding is adjacently near the rotor 10. The stator winding 22 is arranged to extend axially from end portions 20a, 20b of the stator 20, turn outside of the end portions 20a, 20b and be reintroduced through the end portions, whereby said extending portion 22a of the stator winding forms a so called coli end 22b.

The electrically conductive wires of the stator 20 is according to a variant arranged to run axially in slots or apertures of said stator plates, whereby the different wire segments are arranged to be guided out from the end portions 20a, 20b of the stator 20 from a slot or aperture of the stator plates and back into a different slot or aperture of the stator plates.

The stator 20 also it has an envelope surface 24a also referred to as stator back. The stator 20 thereby constitutes a cylindrical housing surrounding the rotor 10 so that the entire envelope surface 12a of the rotor 12a is entirely surrounded by an interior surface or inner surface 24b of the stator 20 in the radial direction of the rotor 10. The exterior surface alike envelope surface 12 of the rotor 10 is arranged adjacently and separated from said interior surface 24b of the stator 20, whereby an air gap is formed between the rotor 10 and the stator 20.

The stator winding 22 of the stator 20 is according to the present invention arranged to run along, extend axially from and turn outside of the envelope surface of the stator 20.

The electric motor 1 further comprises a motor housing 30 enclosing the components, including the rotor 5 and the stator 7, comprised in the electric motor 1. The motor housing 30 comprises wall elements 30a 30b enclosing the rotor/stator arrangement in its axial directions, which wall elements hereinafter will be referred to as end walls 30a, 30b of the motor housing, and wall elements 30c which encloses the rotor/stator arrangement in its radial directions and which hereinafter will be referred to as the envelope walls 30c of the motor housing. The motor housing 30 may have a substantially arbitrary shape but is generally cylinder shaped whereby the envelope walls 30c of the motor housing constitutes an envelope surface in the form of a cylindrical housing enclosing the envelope surface 24a of the stator 20, and whereby the end walls 30a, 30b of the motor housing constitutes substantially circularly shaped end portions of said cylindrical housing which are arranged exteriorly and encloses the end portions of the rotor and the stator 10a, 10b 20a, 20b.

According to the embodiment illustrated in FIG. 2 the electric motor 1 is arranged concentrically in the housing 30 so that the centre axis of the housing aligned with the centre axis of the electric motor X. According to an alternative variant the electric motor is arranged eccentrically in the housing so that the centre of rotation of the drive shaft of the electric motor extends substantially parallel with and at a distance from the centre axis of the housing, this so as to create a desired space between the electric motor and the housing. This space is advantageously freed under the electric motor for example for an oil sump. The space may be used for a differential configuration.

The system I for cooling comprises at least one cooling medium applicator 40 arranged to apply a cooling medium L onto said stator 20. Said cooling medium applicator 40 is moveably arranged relative said stator 20 so that the cooling medium L by means of the movement of the cooling medium applicator is applied onto different areas of said stator 20. The cooling medium applicator 40 is arranged to apply the cooling medium at least onto the end portions 20a, 20b of said stator 20 and hereby the coil ends 22a, 22b of the stator winding 22.

The cooling medium according to an embodiment comprises a liquid cooling medium. The liquid cooling medium is according to an embodiment comprised of oil. The cooling medium applicator 40 hereby constitutes a cooling medium applicator for application of a cooling medium in the form of a cooling liquid.

The cooling medium applicator 40 may be arranged and supported in any suitable fashion and in any suitable location adjacent to the stator 20 for cooling of the stator.

The cooling medium applicator 40 is according to an embodiment arranged to be supported by said housing 30.

The system I according to FIG. 2 illustrates a number of variants of how the cooling medium applicator could be supported.

Hereby it is illustrated cooling medium applicators 40 supported by means of the end wall 40 of said housing 30.

Furthermore it is shown a cooling medium applicator 40 supported by means of the rotor shaft of said rotor.

Yet further a cooling medium applicator 40 is shown supported by the envelope wall 30c of the housing 30. Such placement of the cooling medium applicator 40 is facilitated in an electric motor wherein the electric motor is arranged eccentrically in the housing in a way that the centre of rotation of the drive shaft of the electric motor extends substantially parallel with and at a distance from the centre axis of the housing wherein the cooling medium applicator is interiorly arranged on the envelope wall in connection to the thus formed space.

Said cooling medium applicator 40 comprises at least one nozzle 42 for ejection of said cooling medium and a holder 44 for supporting said nozzle.

The nozzle 42 is according to an embodiment moveably arranged relative to said holder 44.

According to an embodiment said holder 44 is moveably arranged relative to said stator 20. According to an embodiment said holder 44 is moveably arranged relative to the attachment point, i.e. moveably arranged relative to the location where it is supported, for example end wall 30a, 30b of the housing 30, envelope wall of the housing 30 or the rotor shaft 14, so that the cooling medium L is distributed onto different areas of the stator 20.

According to an embodiment said nozzles 42 are arranged directly in the housing 30, for example the end wall portion 30a, 30b of the housing, interiorly of the envelope wall 30c of the housing 30 or the rotor shaft, wherein the housing for this case constitutes the holder 44.

The movement of the cooling medium applicator 40 is controllably arranged. Hereby is enabled to a distribution of cooling medium onto the stator adapted to the needs. One or more of said cooling medium applicators 40 are hereby to be controlled based on a cooling need of the stator so that the cooling medium is applied onto areas of the stator having a cooling need. According to an embodiment all cooling medium applicators are arranged to be controlled.

The system I hereby comprises means for controlling said cooling medium applicators 40. The means for controlling said cooling medium applicators comprises an electronic control unit 100. The electronic control unit 100 is communicatively connected with the respective cooling medium applicator 40. The electronic control unit 100 is arranged to via a respective link L1, L2, L3, L4 transmit a signal to the cooling medium applicator representing control data for control of the cooling medium applicators so that the cooling medium is applied onto the stator where a cooling exists.

The system I comprises means 110 for determining a cooling need of the stator. The electronic control unit 100 is communicatively connected to the means 110 for determining the cooling need of the stator. The electronic control unit 100 is arranged to via a link 110a receive a signal from the means 110 representing data for cooling need of the stator comprising a cooling need of different areas of the stator.

The means 110 for determining the cooling need according to an embodiment comprises one or more sensor units such as temperature sensors arranged to sense a temperature of the stator and its windings. By means of thus determining the cooling need of the stator comprising determining a cooling need of different areas of the stator control of the cooling medium applicator for application of the cooling medium onto areas where a particular cooling need exists is facilitated.

According to an alternative or complementing variant the means 110 for determining the cooling need comprises the power electronics supplying the electric motor 1. The power electronics connected to the electronic control unit 100 or other control unit may hereby sense for example the case where it is a deviation in one of the phases whereby the deviation in concluded and hereby the resulting consequence in the form of an increased cooling need of a particular area of the stator 20.

The cooling need of the electric motor 1 is often largest in the stator winding 22 of the stator 20 and in particular in the coil ends 22a, 22b.

In case of a transitioning from a very high torque to a very high speed the loss is moved from the stator winding and more out to the stator plates/iron of the stator 20 and hereby the envelope surface 24a of the stator. Consequently, at max load of the electric motor, i.e. slow and high torque the losses will mainly appear in the copper windings of the stator. In for example a hybrid motor intended to be operated within a large span the effect will be that at increasing speed the losses are moved out to the iron of the stator back. By means of in this case controlling the cooling by means of activating the cooling medium applicator intended for cooling of the envelope surface of the stator 20, according to a variant arranged interiorly of the envelope wall 30c, efficient cooling is enabled of the envelope surface 24a/stator back of the stator when the need is greatest there.

The electronic control unit 100 is hereby according to a variant arranged to receive information about speed and torque of the electric motor and based on this information control cooling so that cooling takes place at a larger extent on the stator back of the stator when the need exists. Hereby is enabled to additionally improve the performance of the electric motor since a wider performance spectrum is provided.

With reference to FIG. 2 the system I for cooling according to the invention further comprises a cooling medium circuit, according to a variant a liquid cooling circuit, comprising a pump unit 50 arranged by means of a pump comprised in the pump unit to supply pressurised cooling medium to the cooling medium applicators 40 via conduits C1, C2, C3, C4. The conduits C1, C2, C3, C4 is according to a variant connected to the pump unit 50 and the cooling medium applicators 40 so that if one or more cooling medium applicators are de-activated so that no flow is allowed through a de-activated cooling medium applicators, i.e. through the nozzle of a de-activated cooling medium applicator, a higher flow is provided through the or those cooling medium applicators still being activated, i.e. higher flow velocity of the cooling medium through the cooling medium applicator/nozzle.

The system I comprises means for de-activating at least one cooling medium applicator 40 so that a larger flow of cooling medium is allowed in cooling medium applicators 40 still being activated. The means for de-activating at least one cooling medium applicator 40 according to an embodiment comprises de-activation of at least one nozzle 42, i.e. stopping the flow through the nozzle. The means for de-activating at least one cooling medium applicator according to an embodiment comprises the electronic control unit 100. By selecting to turn off certain cooling medium applicators, according to a variant turning off nozzles of certain cooling medium applicators/certain nozzles of cooling medium applicators, the flow increases in other cooling medium applicators. De-activation to prevent a flow through a cooling medium applicator 40/nozzle 42 according to variant comprises closing of a valve member.

For some embodiments the pump of the pump unit 50 is arranged to generate a substantially constant pressure of the cooling medium L and thereby a substantially constant outflow of the cooling medium L being ejected from the moving cooling medium applicators 40 in direction towards the end portions 20a, 20b of the stator.

For other embodiments the system I may comprise a control unit controlling the pump of the pump unit 50 to adapt the outflow of cooling medium L based on various control parameters. For example the control unit can be arranged to control the outflow of cooling liquid from the cooling medium applicators 40 based on one or more control parameters comprising the speed of the electric motor and/or at least one temperature indication being indicative for the temperature of the electric motor or components comprised therein.

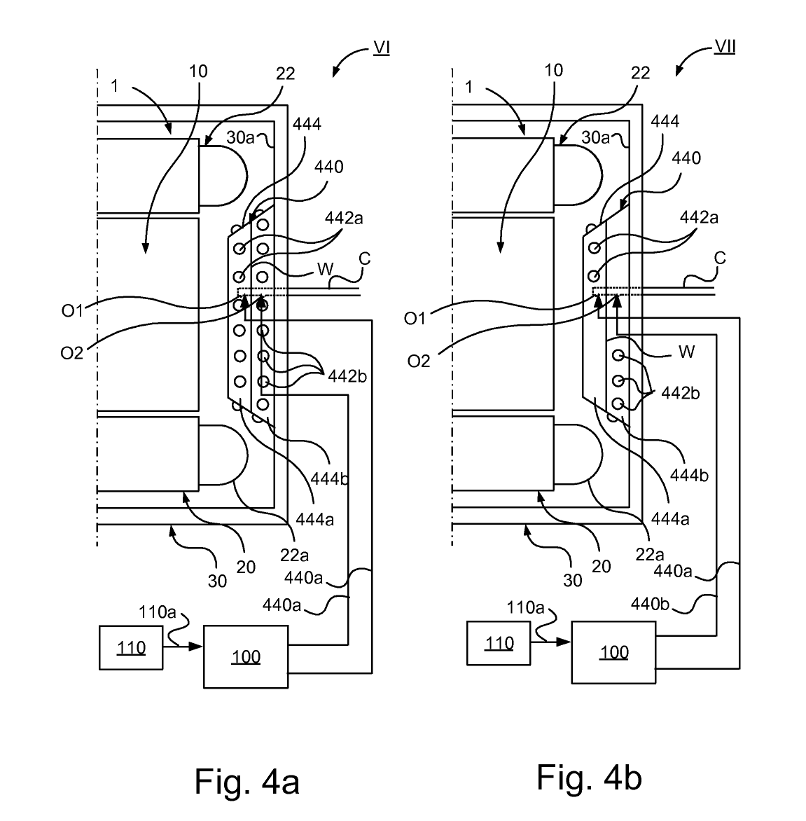

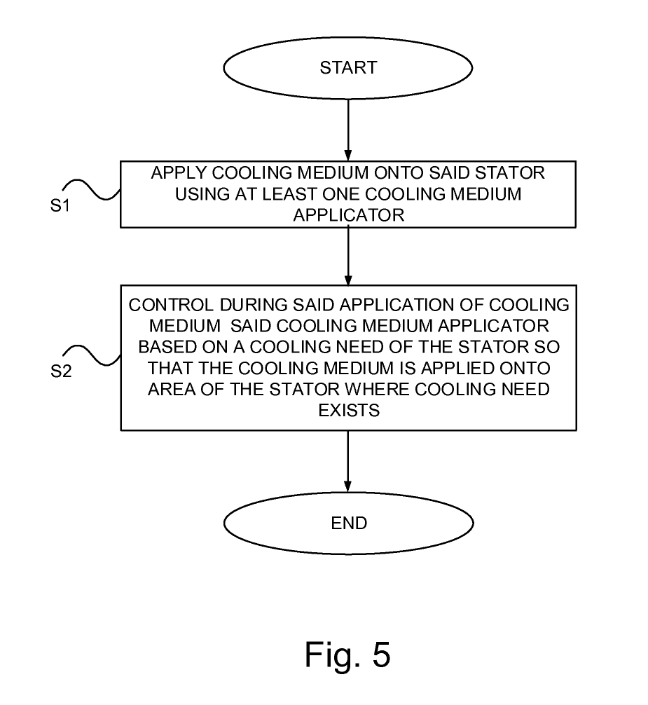

The control unit is according to an embodiment comprised in the pump unit 50. The control unit may be comprised of the above mentioned electronic control unit 100 which is also described with reference to FIGS. 3a, 3b, 3c, 3d, 4a and 4b for control of the movement of the cooling medium applicators. The control unit for controlling the pump of the pump unit 50 may be comprised of an external pump unit. The control unit for control of the pump of the pump unit 50 and the control unit 100 for control of the movement of the cooling medium applicators may be comprised of separate control units.

The system I is further according to an embodiment arranged for re-cycling of the cooling medium which by means of the cooling medium applicators 40 have been applied onto the components of the electric motor for the purpose of cooling these. Thereby the system I may comprise a cooling liquid tray or other gathering device for gathering of the cooling medium having been flushed onto the motor components, and a cooling liquid conduit for transport of the cooling liquid L via the pump unit 50 back to the cooling medium applicator for renewed flushing onto the electric motor components.

For efficient cooling of the cooling medium L and the components onto which it is flushed the cooling device advantageously comprises a cooler arranged to cool the cooling medium L before it is re-used that is after it has been gathered following ejection towards the motor components by the cooling medium applicators and before it has been re-supplied to the cooling medium applicators 40 for renewed ejection. The cooler is generally arranged exterior to the motor housing 30 and may for some embodiment be comprised in the pump unit 50 so as to thereby constitute a combined pump- and cooling component which in a space conservative manner can be installed along the cooling liquid conduit. The cooler for cooling of the cooling medium may be configured and shaped for cooling of the cooling medium L according to any known principles for cooling.

FIG. 3a-d schematically illustrated a system II; III; IV; V with cooling medium applicators 40; 140; 240; 340 according to embodiments of the present invention. The cooling medium applicators 40; 140; 240; 340 have been illustrated as supported by means of the housing 30 of the electric motor. The cooling medium applicator 40; 140; 240; 340 may be supported in any suitable fashion.

The system II; III; IV; V comprises an electronic control unit 100. The electronic control unit 100 is communicatively connected to the cooling medium applicators 40; 140; 240; 340. The electronic control unit 100 is communicatively connected to means 110 for determining the cooling need of the stator.

Said means 110 for determining the cooling need of the stator comprises according to an embodiment sensor members comprising one or more sensor units. Said sensor member is arranged to sense the temperature of the stator and the stator winding for thus being able to identify areas having a particular need for cooling. Hereby for example upon fault conditions when a certain winding runs hot due to isolation having been worn down or similar the cooling medium applicator is controlled so that cooling medium is applied onto the winding having run extra hot.

The electronic control unit 100 is hereby arranged to via links receive signals representing data for cooling need of windings of the stators.

The cooling medium applicators 40; 140; 240; 340 are arranged to be controlled during application of cooling medium based on the cooling need of the stator.

Said cooling medium applicator 40; 140; 240; 340 comprises at least one nozzle 42; 142; 242; 342 for ejection of said cooling medium L and a holder 44; 144; 244; 344 for supporting said nozzle.

FIG. 3a schematically illustrates a system II for cooling of an electric motor comprising a set of cooling medium applicators 140 according to an embodiment of the present invention. The respective cooling medium applicator 140 comprises a nozzle 142 and a holder 144. The system II according to this example comprises three cooling medium applicators 40.

The system II comprises an electronic control unit 100. The electronic control unit 100 is communicatively connected to the respective cooling medium applicators 40 via links 40a, 40b, 40c. The electronic control unit 100 is communicatively connected to a first cooling medium applicator 40 via a link 40a. The electronic control unit 100 is communicatively connected to a second medium applicator 40 via a link 4b. The electronic control unit 100 is communicatively connected to a second medium applicator 40 via a link 4c.

The electronic control unit 100 is communicatively connected to the means 110 for determining cooling need of the stator. The electronic control unit 100 is arranged to via a link 110a receive a signal from the means 110 representing data for cooling need of the stator comprising cooling need of different areas of the stator.

The electronic control unit 100 is arranged to send a signal via link representing de-activation data for de-activation of at least one of said cooling medium applicators 40 so that a larger flow of cooling medium is allowed in cooling medium applicators 40 still being activated.

Said cooling medium applicators 40 are according to a variant controllably moveable relative to the stator. The electronic control unit 100 is according to a variant arranged to send a signal via link to cooling medium applicators still being activated representing control data for control of said cooling medium applicator so that it can be directed towards the area of the stator where a cooling need has been determined to exist.

The electronic control unit 100 is according to a variant arranged to send a signal via link for de-activation of at least one nozzle 42, i.e. stopping the flow through the nozzle 42.

The system II comprises a cooling medium circuit, according to a variant a cooling liquid circuit, comprising a pump unit 50 arranged by means of a pump comprised in the pump unit to supply pressurised cooling medium to the cooling medium applicators 40 via conduits C1, C2, C3. The conduits C1, C2, C3 are coupled to the pump unit 50 and the cooling medium applicators 40 so that if one or more of the cooling medium applicators are de-activated results in that no flow is allowed through a de-activated cooling medium applicator 40, i.e. through the nozzle of a de-activated cooling medium applicator, a larger flow is provided through the/those cooling medium applicators still being activated. The cooling medium applicators 40 is hereby supplied with cooling medium from a joint cooling medium source wherein the cooling medium is distributed to the respective cooling medium applicator 40 via the conduits C1, C2, C3.

By selecting to shut off some certain cooling medium applicators 40, according to a variant shutting of nozzles 42 of some certain cooling medium applicators the flow increases in others for more efficient cooling using the cooling medium applicator 40 still being activated. De-activation so as to prevent flow through cooling medium applicator 40/nozzle 42 according to a variant comprises closing of a valve member of the system II.

In case the cooling medium applicators 40 comprises nozzles 42 for achieving of the spray functionality such as a liquid mist de-activation of a cooling medium applicator enables maintaining the spray functionality at lower cooling medium flow. Hereby is consequently achieved an energy efficient application of the cooling medium.

According to a variant said nozzle 42 and/or said holder are arranged controllably moveable relative to the stator and according to a variant controllable so that it/they are directed towards the area of the stator where a cooling need has been determined to exist.

FIG. 3b schematically illustrates a system III for cooling of an electric motor with a cooling medium applicator 140 with a set of nozzles 142 according to an embodiment of the present invention. The cooling medium applicator 140 according to this example comprises four nozzles 142. The cooling medium applicator 140 comprises a holder 144 arranged to support said nozzle 142.

The system III comprises an electronic control unit 100. The electronic control unit 100 is communicatively connected to the respective nozzle 142 via links 142a, 142b, 142c, 142d. The electronic control unit 100 is communicatively connected to a first nozzle 142 via a link 142a. The electronic control unit 100 is communicatively connected to a second nozzle 142 via a link 142b. The electronic control unit 100 is communicatively connected to a third nozzle via a link 142c. The electronic control unit 100 is communicatively connected to a fourth nozzle via a link 142d.

The electronic control unit 100 is communicatively connected to means 110 for determining a cooling need of the stator. The electronic control unit 100 is arranged to via a link 110a receive a signal from the means 110 representing data for cooling need of the stator comprising cooling need of different areas of the stator.

The electronic control unit 100 is arranged to send a signal via link representing de-activation data for de-activating at least one of said nozzles 142 so that a larger flow of cooling medium is allowed in nozzles 142 still being activated.

Said nozzles 142 are according to a variant controllably moveable relative to the stator. The electronic control unit 100 is according to a variant arranged to send a signal via link to the nozzle still being activated representing control data for controlling said nozzle so that it is directed towards the area of the stator where a cooling need has been determined to exist.

By selecting to shutting of some certain nozzles 142 of some certain cooling medium applicators the flow increases in other for more efficient cooling using nozzles 142 still being activated. De-activation for preventing the flow through the cooling medium applicator 140/nozzle 142 according to a variant comprises closing a valve member of the system III.

In case the cooling medium applicator 140 comprises nozzles 142 for achieving of the spray functionality such as a liquid mist de-activation of a cooling medium applicator enables maintaining the spray functionality at lower cooling medium flows. Hereby is consequently provided an energy efficient application of the cooling medium.

According to a variant said nozzles and(or the holder 144 are arranged controllably moveable relative to the stator and according to variant controllable so that the/they are directed towards areas of the stator where the cooling need has been determined to exist.

FIG. 3c schematically illustrated a system IV for cooling of an electric motor with a cooling medium applicator 240 according to an embodiment of the present invention.

The cooling medium applicator 240 comprises a nozzle 242 and a holder 244.

According to this embodiment the cooling medium applicator 240 is arranged to be controlled by controlling the movement of said holder 244 relative to said stator 20. The holder 244 is according to this embodiment arranged moveable relative to said stator. The holder 244 according to this embodiment moveably attached to the housing 30. Hereby the entire holder 244 is allowed to move relative the housing 30. The nozzle 242 is according to a variant fixedly attached to the nozzle 244. Hereby according to this embodiment the entire cooling medium applicator 240 moves, i.e. the nozzle 242 moves jointly with the holder 244.

Upon movement of the holder 244 the cooling medium L is hereby distributed onto different areas of the stator for cooling.

The system IV comprises an electronic control unit 100. The electronic control unit 100 is communicatively connected to the cooling medium applicator 240 via a link 244a.

The electronic control unit 100 is communicatively connected to means 110 for determining the cooling need of the stator. The electronic control unit 100 is arranged to receive a signal via a link 110a from the means 110 representing data for cooling need of the stator comprising cooling need of different areas of the stator.

The electronic control unit 100 is arranged to send a signal via the link 244a representing control data for controlling said holder 244 so that is may be directed towards the areas of the stator where a cooling need has been determined to exist.

According to a variant also the nozzle 242 is arranged controllably moveable relative to the stator and according to a variant controllably so that it is directed towards the area of the stator where a cooling need has been determined to exist.

FIG. 3d schematically illustrated a system IV for cooling of an electric motor with a cooling medium applicator 340 according to an embodiment of the present invention.

The cooling medium applicator 340 comprises a nozzle 342 and a holder 344.

According to this embodiment the cooling medium applicator 340 is arranged to be controlled by means of controlling the movement of said nozzle 342 relative to said stator 20.

The nozzle 342 according to this embodiment is moveably arranged relative to said stator. The holder 344 according to this embodiment is fixedly attached to the housing 30. Hereby the nozzle 342 is allowed to move relative to the housing 30. The nozzle 342 is moveably attached to the holder 344. Hereby according to this embodiment the entire nozzle moves relative to the holder 344.

Upon movement of the holder the nozzle hereby distributes the cooling medium L onto different areas of the stator for cooling.

The system V comprises an electronic control unit 100. The electronic control unit 100 is communicatively connected to the cooling medium applicator 340 via a link 342a.

The electronic control unit 100 is communicatively connected to means 110 for determining the cooling need of the stator. The electronic control unit 100 is arranged to via a link 110a receive a signal from the means 110 representing data for cooling need of the stator comprising a cooling need of different areas of the stator.

The electronic control unit 100 is arranged to send a signal via the link 342a representing control data for control of said nozzle 342 so that it is directed towards the area of the stator where a cooling need has been determined to exist.

According to a variant also the holder 342 is controllably moveable relative to the stator and according to a variant controllable so that it is directed towards the area of the stator where a cooling need has been determined to exist.

FIG. 4a schematically illustrates a system VI for cooling of an electric motor 1 with a cooling medium applicator 440 having double chambers 444a, 444b with nozzles 442a, 442b coupled to a respective chamber according to an embodiment of the present invention.

The electric motor 1 has a rotor 10 and a stator 20. The electric motor 1 according to a variant comprises the electric motor 1 illustrated in FIG. 2. The electric motor 1 I housed in a housing 30 having an end wall portion 30a.

The cooling medium applicator 440 is arranged on the end wall portion 30a of the housing 30.

Hereby the cooling medium applicator 440 comprises nozzles 442a, 442b and a holder 444, wherein the holder 444 comprises a first chamber 444a and a second chamber 444b separable from the first chamber 444a by means of a partition wall W.

The holder 444 is arranged on the end wall portion 30a. The holder 444 according to a variant has a truncated conical shape. The holder 444 comprises said first chamber 444a and the second chamber 444b. The first chamber 444a constitutes the chamber arranged closest to the end wall portion of the electric motor 1 and the second chamber 444b is arranged on the end wall portion 30a of the housing 30.

The first chamber 444a has nozzles coupled to the chamber 444a and distributed around the chamber 444a and directed towards the electric motor 1 and the stator 20 and the winding 22 of the stator for cooling by means of cooling medium supplied by the chamber.

The second chamber 444b has nozzles coupled to the chamber 444b and distributed around the chamber 444b and directed towards the electric motor 1 and the stator 20 and the winding 22 of the stator for cooling by means of cooling medium supplied by the chamber.

The first and second chambers 444a, 444b are connected by a conduit C for supply of cooling medium. The conduit C has a first closeable opening O1 for supply of cooling medium to the first chamber 444a and a second closeable opening O2 for supply of cooling medium to the second chamber 444b.

The system VI comprises an electronic control unit 100. The electronic control unit 100 is communicatively connected to the first chamber 444a of the cooling medium applicator 440 via a link 440a. The electronic control unit 100 is communicatively connected to the second chamber 444b of the cooling medium applicator 440 via a link 440b

The electronic control unit 100 is communicatively connected to means 110 for determining a cooling need of the stator. The electronic control unit 100 is arranged to via a link 110a receive a signal from the means 110 representing data for cooling need of the stator comprising a cooling need of different areas of the stator.

The electronic control unit 100 is arranged to send a signal via the link 440a representing activation data for activation/de-activation of supply of cooling medium to the first chamber 444a.

The electronic control unit 100 is arranged to send a signal via the link 440b representing activation data for activation/de-activation of supply of cooling medium to the second chamber 444b.

By thus controllably shutting off one chamber from the joint supply of cooling medium the nozzles of the chamber having been shut off are de-activated. Hereby is enabled an increased flow through the chamber not being shut off. De-activation of supply of cooling medium to the first or second chambers 444a, 444b so as to prevent a flow through the nozzles 442a, 442b according to a variant comprises closing of valve members. Said valve members are according to a variant arranged adjacent to a respective closeable opening O1, O2 for closure of the same.

The nozzles 442a, 442b are according to a variant arranged controllable so that they can be directed for controlled cooling. The nozzles 442a, 442b are according to an embodiment arranged to be targeted controlled by means of the electronic control unit 100.

FIG. 4b schematically illustrates a system VII for cooling of and electric motor with a cooling medium applicator 440 with double chambers 444a, 444b with nozzles 442a, 442b coupled to a respective chamber according to an embodiment of the present invention.

The embodiment in FIG. 4b differs from the embodiment according to FIG. 4a in the way that the nozzles of the respective chambers 444a, 444b are arranged.

In this embodiment the first chamber 444a has nozzles 442a directed towards a specific area of the stator 20 and the second chamber 444b has nozzles 442b directed towards another specific area of the stator.

By closing one of the first or second chamber 444a, 444b such as have been described with reference to FIG. 4a targeted directed cooling is hereby enabled.

De-activation of nozzles of one chamber by closure of this chamber consequently results in directed cooling of an area and de-activation of nozzles of the other chamber results in directed cooling towards the other area, for both cases with an increased flow compared to if both chambers/nozzles of both chambers where to be active.

The nozzles 442a, 442b are according to a variant arranged controllable so that they can be directed for directed cooling. The nozzles 442a, 442b are according to a variant arranged to be directed controlled by means of the electronic control unit 100.

In the above embodiment illustrated with reference to FIGS. 4a and 4b cooling a medium applicator 440 with two chambers 444a, 444b have been shown. The cooling medium applicators may have an arbitrary number of chambers, i.e. more than two chambers.

In the above embodiment illustrated with reference to FIGS. 4a and 4b cooling a medium applicator 440 with an outer chambers and an interior chamber 444a, 444b have been shown. The chambers may be oriented in any suitable fashion such as adjacent to each other.

The cooling medium applicator with chambers may have any suitable shape.

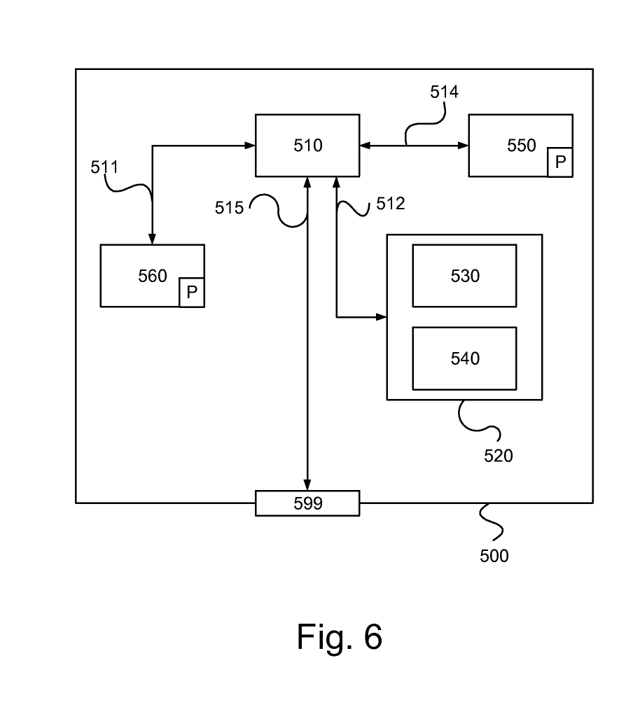

FIG. 5 schematically illustrates a flow diagram of a method for cooling of an electric motor having a rotor and a stator.

According to an embodiment the method for cooling of such electric motor comprises a method step S1. In this step a cooling medium is applied onto said stator by means of at least one cooling medium applicator.

According to an embodiment the method for cooling of such electric motor comprises a method step S2. In this step during said application of the cooling medium L said cooling medium applicator is controlled based on a cooling need of the stator so that the cooling medium is applied onto an area of the stator where the cooling need exist.

According to an embodiment of the method the step of controlling said cooling medium applicator comprises the step of directing said cooling medium applicator towards the area of the stator where the cooling need exist by means of moving said cooling medium applicator relative to said stator.

According to an embodiment the method comprises the step of ejecting said cooling medium by means of a nozzle supported by a holder for said nozzle.

According to an embodiment of the method the step of controlling said cooling medium applicator comprises controlling the movement of said nozzles relative to said holder.

According to an embodiment of the method the step of controlling said cooling medium applicator comprises the step of controlling the movement of said holder relative to said stator.

According to an embodiment application of cooling medium is performed by means of at least two cooling medium applicators, wherein the step of controlling comprises the step of de-activating at least one cooling medium applicators so that a larger flow of cooling medium is allowed in the cooling medium applicators still being activated.

According to an embodiment application of cooling medium is performed by means of at least one cooling medium applicator comprising at least two nozzles, wherein the step of controlling comprises the step of de-activating at least one nozzle so that a larger flow of cooling medium is allowed in the nozzle still being activated.

According to an embodiment the method comprises the step of determining a cooling need before the step of application of cooling medium is performed.

With reference to FIG. 6 a diagram of an embodiment of a device 500 is shown. The control unit 100 as has been described with reference to FIG. 2 can in an embodiment (now shown) comprises the device 500. The device 500 comprises a non-volatile memory 520, a data processing device 510 and a read/write memory 550. The non-volatile memory 520 has a first memory portion 530 wherein a computer program, such as an operating system, is stored for controlling the function of the device 500. The device 500 further comprises a bus-controller, a serial communication port, I/O-means, an A/D-converter, a time date entry and transmission unit, an event counter and an interrupt controller (not shown). The non-volatile memory 520 also has a second memory portion 540.

A computer program P comprising routines for cooling of an electric motor according to the inventive method is provided. The program P comprises routine for application of a cooling medium onto said stator by means of at least one cooling medium applicator. The program P comprises routines for during said application of cooling medium controlling said cooling medium applicator based on a cooling need of the stator so that the cooling medium is applied onto areas of the stator where a cooling need exist. The routines for control of said cooling medium applicator comprises routine for directing said cooling medium applicator towards the area of the stator where the cooling need exist by means of moving said cooling medium applicator relative to said stator. The program P comprises routines for ejection of said cooling medium by means of a nozzle supported by a holder for said nozzle. The routines for control of said cooling medium applicator comprises routine for controlling movement of said nozzle relative to said holder. The routines for control of said cooling medium applicator comprises routines for controlling of movement of said holder relative to said stator. The program P comprises routines for determining a cooling need of the stator before application of cooling medium is performed. The program P may be stored in an executable or compressed manor in a memory 560 and/or in a read/write memory 550.

When it is stated that the data processing device 510 performs a certain function it should be understood that the data processing device 510 performs a certain part of the program which is stored in the memory 560, or a certain part of the program which is stored in the read/write memory 550.

The data processing device 510 may communicate with a data port 599 via a data bus 515. The non-volatile memory 520 is adapted for communication with the data processing device 510 via a data bus 512. The separate memory 560 is adapted for communication with the data processing device 510 via a data bus 511. The read/write memory 550 is arranged to communicate with the data processing device 510 via a data bus 514. The data port 599 may for example be connected to the links of the control unit 100.

When data is received on the data port 599 it is temporarily stored in the second memory portion 540. When the received input data has been temporary stored, the data processing device 510 is set up to perform execution of code in a manner described above. The signals received on the data port 599 may be used by the device 500 for application of cooling medium onto said stator using at least one cooling medium applicator. The signals received on the data port 599 may be used by the device 500 for during application of cooling medium to control said cooling medium applicator based on a cooling need of the stator so that the cooling medium is applied onto areas of the stator where a cooling need exist. The signals received on the data port 599 may be used by the device 500 for controlling said cooling medium applicator by the step of directing said cooling medium applicator towards the area of the stator where a cooling need exist by means of moving said cooling medium applicator relative to said stator. The signals received on the data port 599 may be used by the device 500 for ejection of said cooling medium by means of at least one nozzle supported by a holder for said nozzle. The signals received on the data port 599 may be used by the device 500 for controlling the movement of said nozzle relative to said holder. The signals received on the data port 599 may be used by the device 500 for controlling the movement of said holder relative to said stator. The signals received on the data port 599 may be used by the device 500 for determining a cooling need of the stator before application of cooling medium takes place.

Parts of the methods described herein may be performed by the device 500 assisted by the data processing device 510 running the program stored in the memory 560 or in the read/write memory 550. When the device 500 runs the program, the methods described herein are executed.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

1. A method for cooling of an electric motor having a rotor and a stator, comprising the steps of:
applying a cooling medium onto said stator using at least one cooling medium applicator; and during said application of cooling medium controlling said at least one cooling medium applicator based on a cooling need of the stator so that the cooling medium is applied onto areas of the stator where a cooling need exist.

2. The method according to claim 1, wherein the step of controlling said cooling medium applicator comprises the step of directing said cooling medium applicator towards the area of the stator where the cooling need exist by moving said cooling medium applicator relative to said stator.

3. The method according to claim 1, comprising the step of ejecting said cooling medium using at least one nozzle supported by a holder for said at least one nozzle.

4. The method according to claim 3, wherein the step of controlling said cooling medium applicator comprises the step of controlling movement of said at least one nozzle relative to said holder.

5. The method according to claim 3, wherein the step of controlling said cooling medium applicator comprises controlling movement of said holder relative to said stator.

6. The method according to claim 1, wherein application of cooling medium is performed using at least two cooling medium applicators, wherein the step of controlling comprises de-activating at least one cooling medium applicator so that a larger flow of cooling medium is allowed in the cooling medium applicator still being activated.

7. The method according to claim 1, wherein application of cooling medium is performed using at least one cooling medium applicator comprising at least two nozzles, wherein the step of controlling comprises the step of de-activating at least one nozzle so that a larger flow of cooling medium is allowed in the nozzle the being activated.

8. The method according to claim 1, further comprising the step of determining the cooling need of the stator before the step of application of cooling medium is performed.

9. A system for cooling of an electric motor having a rotor and a stator, comprising:,
at least one cooling medium applicator arranged to apply a cooling medium onto said stator, wherein said cooling medium applicator is arranged to be controlled based on a cooling need of the stator so that the cooling medium is applied onto areas of the stator where the cooling need exist.

10. The system according to claim 9, wherein said cooling medium applicator is moveably arranged relative to said stator for directed control of said cooling medium applicator.

11. The system according to claim 9, wherein said cooling medium applicator comprises at least one nozzle for ejection of said cooling medium and a holder for supporting said at least one nozzle.

12. The system according to claim 11, wherein said at least one nozzle is arranged controllably moveable relative to said holder.

13. The system according to claim 11, wherein said holder is arranged controllably moveable relative to said stator.

14. The system according to any of claim 9, wherein said cooling medium applicator is supported by a housing surrounding the electric motor.

15. The system according to claim 14, wherein the cooling medium applicator is supported by an end wall portion and/or an envelope wall of said housing.

16. The system according to any of claim 9, wherein the cooling medium applicator is supported by a rotor shaft of said rotor.

17. The system according to any of claim 9, wherein application of cooling medium is arranged to be performed using at least two cooling medium applicators, and further comprising a device for de-activating at least one cooling medium applicator so that a larger flow of cooling medium is allowed in the cooling medium applicator still being activated.

18. The system according to any of claim 9, wherein application of cooling medium is arranged to be performed using at least one cooling medium applicator, and further comprising at least two nozzles, a device for de-activation of at least one nozzle so that a larger flow of cooling medium is allowed in the nozzle still being activated.

19. The system according to any of claim 9, further comprising a device for determining the cooling need of the stator.

20. A platform comprising a system according to claim 9.

21. The platform according to claim 20, comprising a vehicle.

22. A non-transitory storage medium having a computer program for cooling of an electric motor stored therein, wherein said computer program comprises program code which, when executed by an electronic control unit or other computer connected to the electronic control unit, causes the electronic control unit to perform the steps according to claim 1.

23. (canceled)
